(19) United States
(12) Patent Application Publication
(10) Pub. No.: US 2009/0196057 A1
(43) Pub. Date: Aug. 6, 2009

(54) Side Lights For Work Vehicles

(76) Inventors: Michael David Case, Kechi, KS (US); Carl Joseph Hagele, Chicago, IL (US); Salvatore Virgilio, Woodridge, IL (US); Kyle Brenner, Silvis, IL (US)

Correspondence Address: CNH AMERICA LLC;INTELLECTUAL PROPERTY LAW DEPARTMENT, P O BOX 1895, M.S. 641, NEW HOLLAND, PA, 17557, US

(21) Appl. No.: 12/023,712

(22) Filed: Jan. 31, 2008

(51) Int. Cl. B60Q 1/00; F21V 21/00

(52) U.S. Cl. 362/487; 362/544

(57) ABSTRACT

A work vehicle is provided including a frame having a side and an end, the frame structurally carrying a cab structure having a brim. A housing is configured to receive a first light source and a second light source. The housing is structurally carried by the cab structure in close proximity to the brim and disposed above an operator's viewing position. The first light source provides illumination generally directed perpendicular to the end of the frame, the second light source providing illumination generally directed perpendicular to the side of the frame. The first and second light sources are sufficiently disposed within the cab structure for protection from vertically falling objects.

### FIELD OF THE INVENTION

The present invention relates generally to the field of work vehicles having operator cabs. It relates more particularly to work vehicles having operator cabs with light sources.

### SUMMARY OF THE INVENTION

The present invention relates to a work vehicle including a frame having a side and an end, the frame structurally carrying a cab structure having a brim. A housing is configured to receive a first light source and a second light source. The housing is structurally carried by the cab structure in close proximity to the brim and disposed above an operator's viewing position. The first light source provides illumination generally directed perpendicular to the end of the frame, the second light source providing illumination generally directed perpendicular to the side of the frame. The first and second light sources are sufficiently disposed within the cab structure for protection from vertically falling objects.

The present invention further relates to a light assembly including a housing configured to receive a first light source and a second light source. The first light source provides illumination generally directed in a first direction, the second light source providing illumination generally directed in a second direction substantially perpendicular to the first direction. The housing is adjustably securable to a cab structure of a work vehicle disposed above an operator's viewing position, permitting directional adjustment of at least one of the first and second light source. The housing is sufficiently disposed within the cab structure for protecting the housing and light sources from vertically falling objects.

The present invention further relates to a method of illuminating a work vehicle. The method includes providing a work vehicle including a frame having a side and an end, the frame structurally carrying a cab structure having a brim. The method further includes providing a housing configured to receive a first light source and a second light source. The first light source provides illumination generally directable perpendicular to the end of the frame, the second light source providing illumination generally directable perpendicular to the side of the frame. The method further includes adjustably securing the housing in close proximity to the brim and disposed above an operator's viewing position. The first and second light sources are sufficiently disposed within the cab structure for protection from vertically falling objects, and adjustably securing the housing permits directional adjustment of at least one of the first and second light source.

An advantage of the present invention is a housing containing more than one light source providing illumination in substantially different directions, the housing secured to a cab structure of a work vehicle and protected from substantially vertically directed objects.

A further advantage of the present invention is adjustability of one or more directions of light sources contained in a housing secured to a cab structure of a work vehicle.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a top perspective view of an embodiment of a work vehicle of the present invention.

FIG. 2 is an enlarged partial top perspective view of an embodiment of a light assembly adjustably secured to a cab structure of a work vehicle of the present invention.

FIG. 3 is an enlarged partial bottom perspective view of an embodiment of a light assembly adjustably secured to a cab structure of a work vehicle of the present invention.

FIGS. 4 and 5 are further enlarged partial perspective views of an embodiment of a light housing of the present invention.

Wherever possible, the same reference numbers will be used throughout the drawings to refer to the same or like parts.

### DETAILED DESCRIPTION OF THE INVENTION

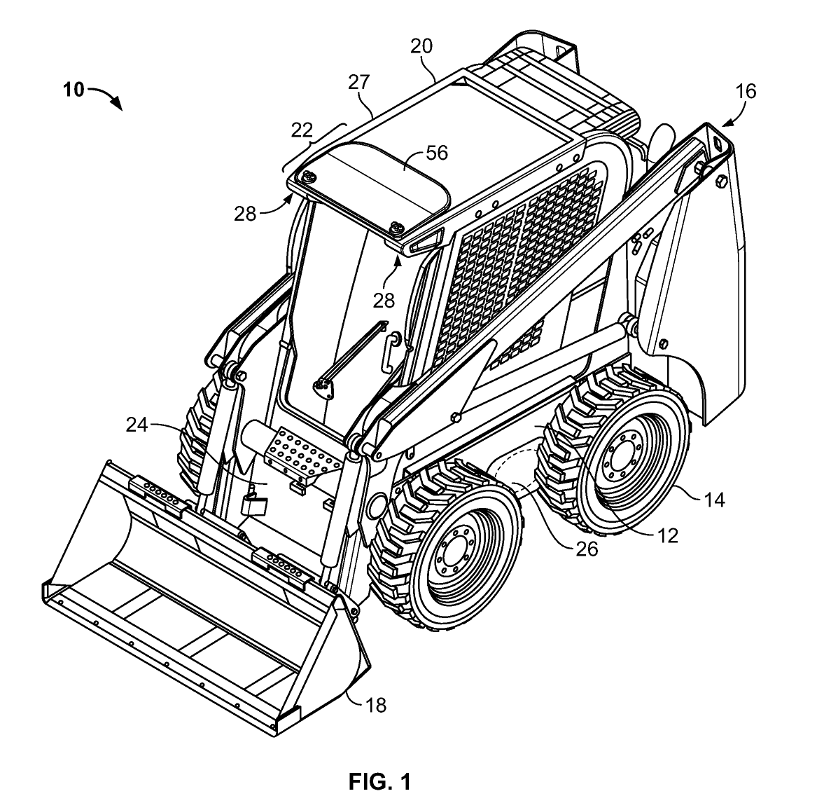

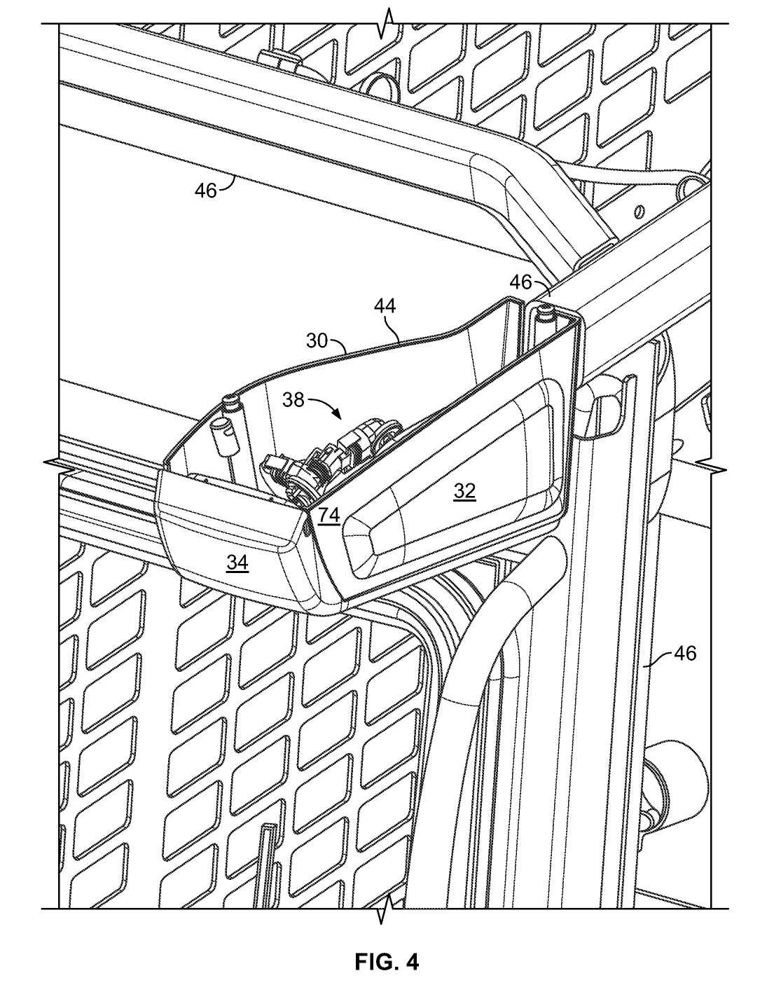

FIG. 1 shows a work vehicle 10 provided with a frame 12 that rotatably carries a plurality of wheels 14. A lifting structure 16 includes an arrangement of structural members and actuators controllable by an operator (not shown) to manipulate an implement 18 to perform work. Frame 12 structurally supports a cab structure 20 to surround and protect the operator, which frame 12 includes a front end 24 facing implement 18, with front end 24 disposed between opposed sides 26, 27. As further shown in FIG. 1, cab structure 20 includes a brow or brim 22 protruding toward end 24, although in an alternate embodiment, brow or brim 22 or additional brows or brims 22 may extend toward opposed sides 26, 27 or toward the end opposite end 24. In one embodiment, a pair of light assemblies 28 is adjustably secured in proximity to each of opposed sides 26, 27 and also proximate to end 24. Each light assembly 28 contains illumination sources or light sources 38 (FIG. 4) for providing additional illumination of the surrounding region exterior of work vehicle 10, permitting an operator (not shown) to more safely operate work vehicle 10.

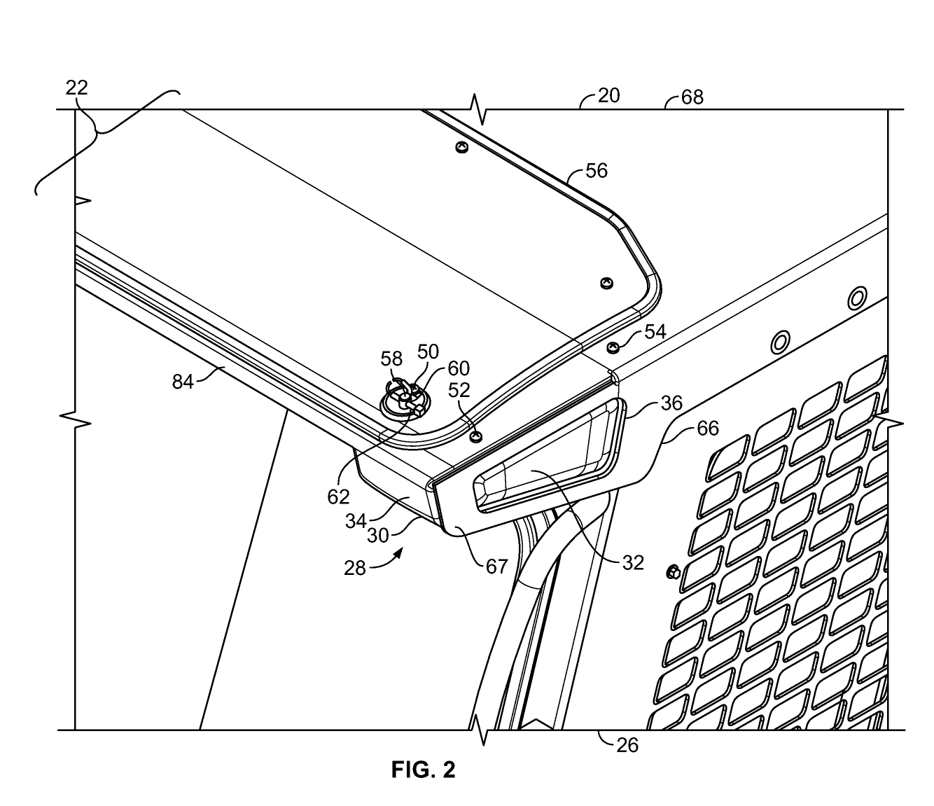

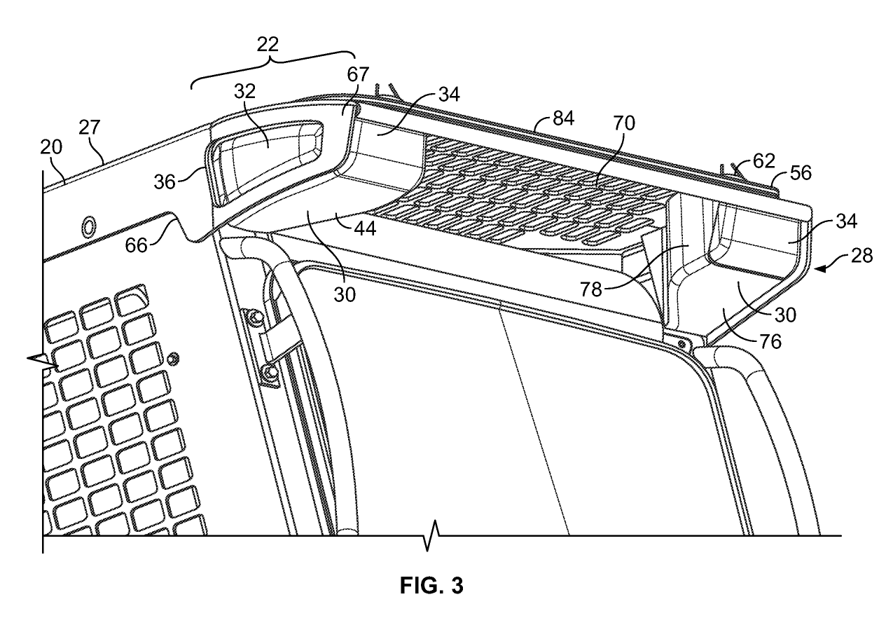

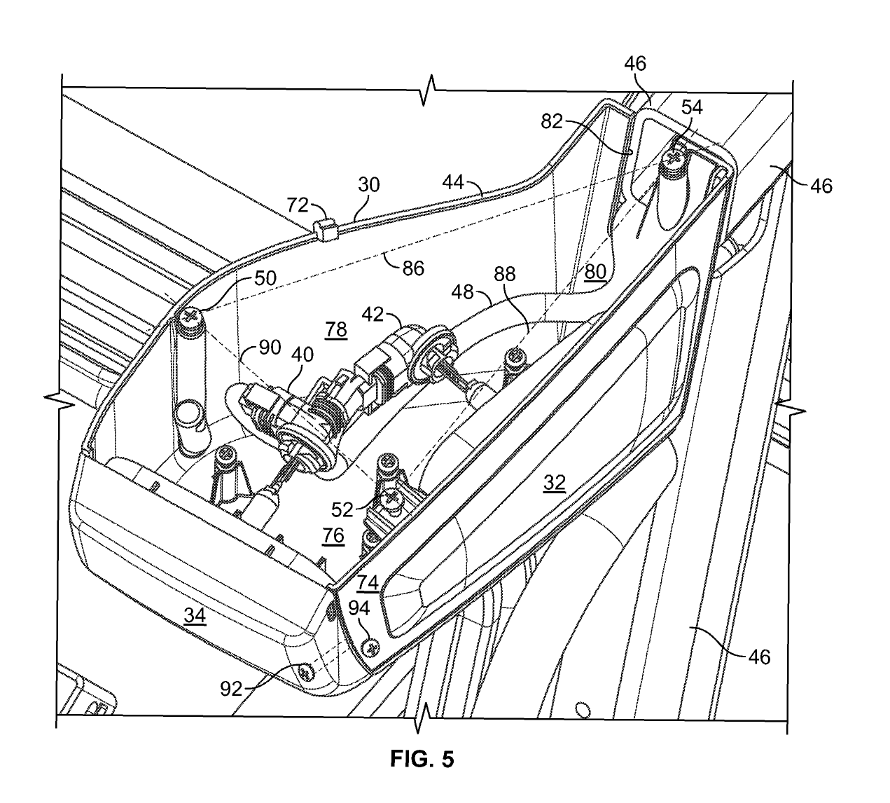

FIGS. 2-3 show respective enlarged top and bottom partial perspective views of a light assembly 28 structurally carried by cab structure 20 of work vehicle 10. More specifically, each light assembly 28 is structurally carried by brim 22. In one embodiment, brim 22 includes a roof 68 that overlies tubular structures 46 (FIG. 4) comprising cab structure 20. As shown in FIG. 2, fasteners 50, 52, 54 adjustably secure light assembly 28 to brim 22. As further shown in FIG. 3, brim 22 includes a plurality of viewing openings 70, arranged to form a lattice in one embodiment, to provide the operator with additional lighting while disposed inside cab structure 20, as well as the ability to view implement 18 when the implement 18 is raised above the cab structure 20. Brim 22 provides structural support for light assembly 28 and substantially protects light assembly 28 from vertically falling objects, as brim 22 is disposed beneath brim 22. In one embodiment, roof 68 includes flange portions 66 that extend partially along respective sides 26, 27 to provide lateral structural support and further protection for light assembly 28. As shown, flange portions 66 each include an aperture 36, with a region 67 surrounding aperture 36 of flange portion 66 for conformally receiving a recessed portion 74 (FIGS. 4, 5) of housing 30. As further shown, brim 22 includes a lip 84 in which the end of brim 22 forms a curved portion having a double thickness, providing a region of increased structural stiffness and strength, as well as providing an alignment feature for installing light assembly 28. That is, lip 84 abuts or is in close proximity to a front-facing diffuser 34 of light assembly 28.

As shown in FIGS. 1 and 2, a cover 56 overlies brim 22 to permit passage of light therethrough, and additionally through viewing openings 70 (FIG. 3) formed in brim 22. In one embodiment, cover 56 is contiguous and substantially transparent. In another embodiment, cover 56 is constructed of a light polarizing material. In one embodiment, brim 22 includes a pair of outwardly extending studs 58 (only one shown in FIG. 2), with each stud 58 received by an opening 60 formed in cover 56. A fastener 62, such as a locking pin fastener in one embodiment that is commonly referred to as a lynch pin, may be used to engage stud 58 to secure cover 56 against brim 22. As further shown in FIG. 2, cover 56 overlies a substantial portion of brim 22, and in an alternate embodiment, overlies brim 22 virtually in its entirety. That is, cover 56 also overlies fasteners 50, 52, 54 adjustably securing light assembly 28 to brim 22, so that light assembly 28 is substantially fluid tight.

As shown in FIGS. 3-5, light assembly 28 includes a housing 30 configured to illuminatingly receive a first light source 40 and a second light source 42 therein. Housing 30 includes a base 44 (FIG. 5) having a lower surface 76, a side surface 78 and a rear surface 80. Rear surface 80 includes a slot 82 formed therein for receiving a wire harness 48 (FIG. 5), routed through tubular structure 46 in one embodiment, providing electrical power from an electrical power source (not shown) to illuminate first and second light sources 40, 42. In one embodiment, base 44 is of unitary construction. In one embodiment, base 44 is constructed of plastic, metal, composites or other suitable material.

As shown in FIG. 5, a side-facing diffuser 32 forms a side surface of housing 30 opposite diffuser side surface 78 of base 44, with edges of diffuser 32 abutting corresponding edges of rear surface 80 and lower surface 76 of base 44. Similarly, diffuser 34 forms a front surface of housing 30, in that it faces end 24 (FIG. 1) of work vehicle 10 in an exemplary embodiment. Thus, it is to be understood that terms such as front, side and lower are merely to aid in describing the exemplary embodiment and are non-limiting. Edges of diffuser 34 abut corresponding edges of side surface 78 and lower surface 76 of base 44, as well as diffuser 32. Upon assembly, such as by snap fit and/or application of adhesives and/or fasteners, diffusers 32, 34 and base 44 define housing 30. In one embodiment, diffusers 32, 34 are constructed of an optically suitable material permitting passage of light therethrough, such as plastic, glass or other suitable material. In an alternate embodiment, housing 30 may be of unitary construction.

The construction of housing 30 protectively secures first light source 40 and second light source 42 therein. As shown, first light source 40 is secured to provide illumination through diffuser 34 generally perpendicular to end 24. Second light source 42 is secured to provide illumination through diffuser 32 generally perpendicular to side 26 (FIG. 2) and side 27 (FIG. 3). In other words, as shown in a single housing 30 of the exemplary embodiment, first and second light sources 40, 42 are disposed in directions that are substantially perpendicular to each other. In applications, such as skid steer loaders, having extremely compact constructions, light sources may be disposed in a light assembly having a single housing, providing illumination in multiple directions, from a position disposed above an operator's viewing position, which maximizes the amount of illumination. The light assembly is located in a position such that lateral illumination would be impinged only briefly and intermittently, such as by operational movement of lifting structure 16 (FIG. 1), e.g., the boom. In alternate embodiments, additional brims and light assemblies may be similarly configured as disclosed herein along the opposite end of work vehicle, if desired, so that at no time would both side facing light sources be impinged during operation of the work vehicle. In addition, by virtue of the construction of brim 22 and housing 30, light assembly 28 is substantially protected from vertically falling objects, due to housing 30. Stated another way, in one embodiment, the first and second light sources 40, 42 are sufficiently disposed within the cab structure 20 for protection from vertically falling objects. That is, in one embodiment, no portion of housing 30 is uncovered from a vantage point vertically above brim 22, as diffuser 32 does not extend through aperture 36 of brim 22.

As is shown in FIGS. 2-3, housing 30 is disposed beneath brim 22 with diffuser 34 abutting or in close proximity to lip 84 of brim 22, which lip 84 providing both enhanced structural support and an alignment feature for the installation of light assembly 28. Additionally, recessed portion 74 of diffuser 32 is conformally received by region 67 of flange portion 66 of brim 22, and in one embodiment, diffuser 32 having a slightly raised diffuser portion extending into aperture 36, with region 67 and aperture 36 providing respective second and third alignment features to further assist with installation of light assembly 28.

As shown in FIG. 5, an optional resilient layer 72 may be applied along the collective upper peripheral lip of housing 30 and/or over tubular structure 46 along slot 82 to provide a substantially fluid tight seal with brim 22 (FIG. 2). As further shown in FIGS. 2 and 5, housing 30 is adjustably secured to brim 22 by fasteners 50, 52, 54. That is, in one embodiment, fasteners 50, 52, 54 may be captive fasteners secured in brim 22, and individually adjustable with respect to brim 22. As can be appreciated by those having ordinary skill in the art, adjustment of fastener 52 with respect to fasteners 50, 54 would pivot housing 30 about an axis 86, providing directional adjustment of each of first and second light sources 40, 42 with respect to brim 22. It is also appreciated that as shown, adjustment of fastener 50 with respect to fasteners 52, 54 would pivot housing 30 about an axis 88, and adjustment of fastener 54 with respect to fasteners 52, 54 would pivot housing 30 about an axis 90 with respect to brim 22. In other words, adjusting a fastener, such as fastener 50, 52, 54, which secures a position of the housing 30 with respect to the brim 22 permits directional adjustment of at least one of the first and second light sources 40, 42. It is further appreciated that other arrangements of fasteners may be used.

It is to be understood that more than two light sources may be used, and that the angular difference between the two or more light sources may be perpendicular or nonperpendicular. In an alternate embodiment, the diffusers may be independently movable with respect to each other and with the brim 22. That is, as shown in FIG. 5, diffusers 32, 34 may be movable by, for example, fasteners 92, 94, permitting independent directional adjustability of each of the respective light sources. The connecting edges between diffusers 32, 34 and housing may be flexible to permit independent movement, while maintaining a substantially fluid tight construction.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A work vehicle comprising:
a frame having a side and an end, the frame structurally carrying a cab structure having a brim;
a housing configured to receive a first light source and a second light source, the housing structurally carried by the cab structure in close proximity to the brim and disposed above an operator's viewing position, the first light source providing illumination generally directed perpendicular to the end of the frame, the second light source providing illumination generally directed perpendicular to the side of the frame, and
wherein the first and second light sources are sufficiently disposed within the cab structure for protection from vertically falling objects.

2. The work vehicle of claim 1, wherein the housing is substantially fluid tight.

3. The work vehicle of claim 1, wherein the housing is adjustably secured to the cab structure, permitting directional adjustment of at least one of the first and second light source.

4. The work vehicle of claim 3, wherein the housing is adjustably secured to the brim.

5. The work vehicle of claim 4, wherein the brim includes a plurality of viewing openings.

6. The work vehicle of claim 5, wherein the viewing openings form a lattice.

7. The work vehicle of claim 5, wherein the brim includes an aperture configured to permit illumination therethrough by the second light source.

8. The work vehicle of claim 6, wherein the lattice is overlain by a contiguous cover.

9. The work vehicle of claim 8, wherein the cover permits passage of light therethrough.

10. The work vehicle of claim 9, wherein the cover is substantially transparent.

11. A light assembly comprising:
a housing configured to receive a first light source and a second light source, the first light source providing illumination generally directed in a first direction, the second light source providing illumination generally directed in a second direction substantially perpendicular to the first direction; and
wherein the housing is adjustably securable to a cab structure of a work vehicle disposed above an operator's viewing position, permitting directional adjustment of at least one of the first and second light source, the housing being sufficiently disposed within the cab structure for protecting the housing and light sources from vertically falling objects.

12. The light assembly of claim 11, wherein the cab structure includes a brim, the housing being adjustably securable to the brim.

13. The light assembly of claim 12, wherein the housing is adjustably secured to the brim by a plurality of fasteners.

14. The light assembly of claim 12, wherein the brim includes a plurality of viewing openings.

15. The light assembly of claim 14, wherein the viewing openings form a lattice.

16. The light assembly of claim 14, wherein the brim includes an aperture configured to permit illumination therethrough by the second light source.

17. The light assembly of claim 15, wherein the lattice is overlain by a contiguous cover.

18. The light assembly of claim 17, wherein the cover permits passage of light therethrough.

19. A method of illuminating a work vehicle, the method comprising:
providing a work vehicle including a frame having a side and an end, the frame structurally carrying a cab structure having a brim;
providing a housing configured to receive a first light source and a second light source, the first light source providing illumination generally directable perpendicular to the end of the frame, the second light source providing illumination generally directable perpendicular to the side of the frame;
adjustably securing the housing in close proximity to the brim and disposed above an operator's viewing position, wherein the first and second light sources are sufficiently disposed within the cab structure for protection from vertically falling objects, and wherein adjustably securing the housing permits directional adjustment of at least one of the first and second light source.

20. The method of claim 19, wherein the step of adjustably securing the housing includes adjusting a first fastener securing a position of the housing with respect to the brim.
